(19) United States
(12) Patent Application Publication
(10) Pub. No.: US 2020/0371506 A1
(43) Pub. Date: Nov. 26, 2020

(54) CONFIGURATION-BASED OPTIMIZATION METHOD OF AUTOMATED ASSEMBLY AND PRODUCTION OF CIRCUIT BREAKER

(71) Applicant: Wenzhou University, Wenzhou (CN)

(72) Inventors: Liang Shu, Wenzhou (CN); Yanfang Yang, Wenzhou (CN); Miao Yang, Wenzhou (CN); Ziran Wu, Wenzhou (CN); Wei Chen, Wenzhou (CN); Guichu Wu, Wenzhou (CN); Xiangou Zhu, Wenzhou (CN)

(21) Appl. No.: 16/698,951

(22) Filed: Nov. 28, 2019

(30) Foreign Application Priority Data
May 23, 2019 (CN) 201910434904.8

(51) Int. Cl. G05B 19/418; G06F 9/30; G06F 17/16

(52) U.S. Cl. CPC G05B 19/41845; G05B 19/4184; G06F 17/16; G06F 9/30145; G05B 19/41805

(57) ABSTRACT

An configuration-based optimization method for automated assembly and production of circuit breakers includes ascertaining names, serial numbers, operating times, costs and maximum parallelism levels of all operation elements, and, based on structural principles and process requirements of the circuit breakers, analyzing the names, serial numbers and operating times of the operation elements, so as to identify assembly precedence and process connection among the operation elements; according to the costs and the maximum parallelism levels of the operation elements, optimizing and adjusting process parallelism levels of the operation elements and their corresponding shunt or confluent unit costs, and taking the assembly precedence, process connection and the optimized and adjusted process maximum parallelism as constraint conditions, with the aim to minimize the assembly line takt time and costs, to build a multi-objective optimization problem; and finding optimal solutions of the multi-objective optimization problem as configuration-based optimization schemes.

### BACKGROUND OF THE INVENTION

### 1. Technical Field

The present invention relates to the field of circuit breakers, and more particularly to a configuration-based optimization method for automated assembly and production of circuit breakers.

### 2. Description of Related Art

Circuit breakers are important protective equipment used in power distribution networks and have been extensively used in various fields of national economy such as power, oil, chemical, and building sectors. Circuit breakers provide protection that is essential to power grid stability as well as personal and property safety. Automated assembly and production lines of circuit breakers are known to have high production quality, good consistency, reliability and stability. To manufacturers of circuit breakers, it is of particular interest to optimize configurations of their automated assembly and production lines with comprehensive consideration to total equipment costs and production efficiency, so as to enhance equipment usage, lower costs, and improve production efficiency.

Currently, optimization of assembly and production lines mainly includes using assembly line balancing, system simulation optimization and lean production optimization. Therein, assembly line balancing involves assigning various operation elements of different types across workstations according to specific algorithms, so as to achieve balance among workstations, thereby optimizing production costs and efficiency. System simulation optimization involves conducting simulation tests of configuration-based optimization schemes for assembly lines, so as to have a picture of real-world assembly operation modes, thereby evaluating candidate configuration schemes. Lean production optimization involves modeling and optimizing inventory control, planning management and quality management to realize “zero-waste” assembly lines.

The three optimization approaches to configuration of assembly and production lines as described above, however, have their shortcomings. Specifically, assembly line balancing dictates reassignment of operation elements/processes, and thus requires more flexibility from assembly lines, making it unsuitable to automated assembly and production lines of circuit breakers. System simulation optimization and lean production optimization are somehow useful for scheme verification and evaluation management if assembly lines, but they are ineffective to multi-objective optimization.

Hence, there is a pressing need to have a configuration-based optimization method for automated assembly and production of circuit breakers, which optimizes automated assembly lines of circuit breakers in terms of equipment cost and production efficiency, so as to serve to assembling operations and production of circuit breakers best.

### SUMMARY OF THE INVENTION

The technical issue for embodiments of the present invention to address is to provide a configuration-based optimization method for automated assembly and production of circuit breakers, which optimizes automated assembly lines of circuit breakers in terms of equipment cost and production efficiency, so as to serve to assembling operations and production of circuit breakers best.

To address the foregoing technical problems, the present invention provides a configuration-based optimization method for automated assembly and production of circuit breakers, comprising the following steps:

Step S1, ascertaining names, serial numbers, operating times, costs and maximum parallelism levels of operation elements of an automated assembly and production line, and, based on structural principles and process requirements of the circuit breakers, analyzing the names, the serial numbers, and the operating times of the operation elements, so as to obtain assembly precedence and process connection among the operation elements of the automated assembly and production line;

Step S2, according to the costs and the maximum parallelism levels of the operation elements, optimizing and adjusting process parallelism levels of the operation elements and their corresponding shunt unit costs or confluent unit costs, and using the assembly precedence, the process connection and the maximum parallelism level among the operation elements as constraint conditions, with an objective to minimize a takt time and the costs of the automated assembly and production line, to build a multi-objective optimization problem; and

Step S3, using Pareto backtracking search optimization algorithm for crowding to find optimal solutions of assembly sequences of the operation elements and their corresponding process parallelism levels in the multi-objective optimization problem, and taking the assembly sequences and their corresponding process parallelism levels happening when the optimal solutions of the multi-objective optimization problem are found as configuration-based optimization schemes of the automated assembly and production line.

The disclosed method further comprises:

acquiring costs of the automated assembly and production line in the configuration-based optimization schemes happening when the optimal solutions of the multi-objective optimization problem are found, and according to the acquired costs of the automated assembly and production line in the configuration-based optimization schemes, figuring out total profits of the configuration-based optimization schemes at an end of a business payback period, and further taking the configuration-based optimization scheme having the greatest total profit as the final configuration-based optimization scheme of the automated assembly and production line.

Therein, Step S2 comprises:

totaling a total number of the operation elements of the automated assembly and production line, and generating two sections of random two-place decimals that are in a number equal to the total number of the operation elements and distributed evenly in an interval of (0,1), as assembly sequence codes and parallelism codes, respectively;

according to the serial numbers of the operation elements as well as the assembly precedence and process connection among the operation elements, decoding the generated assembly sequence codes so as to obtain an assembly sequence of the assembly and production line;

according to the maximum parallelism levels of the operation elements, decoding the generated parallelism codes into the process parallelism level for optimizing and adjusting the operation elements, and according to the costs of the operation elements, further determining shunt unit costs or confluent unit costs corresponding to the optimized and adjusted process parallelism levels of the operation elements;

taking the assembly precedence, the process connection and the maximum parallelism levels among the operation elements as constraint conditions, with an objective to minimize a takt time and the costs of the automated assembly and production line, to build the multi-objective optimization problem.

Therein, the step of according to the serial numbers of the operation elements as well as the assembly precedence and process connection among the operation elements, decoding the generated assembly sequence codes so as to obtain an assembly sequence of the assembly and production line comprises:

mapping the generated assembly sequence codes and the serial numbers of the operation elements, and according to a size of the generated assembly sequence codes, adjusting precedence ranks of the serial numbers of the operation elements, and according to the assembly precedence and process connection among the operation elements, re-adjusting the operation elements having the adjusted serial numbers, further combining the re-adjusted serial numbers of the operation elements into the assembly sequences of the operation elements.

Therein, the step of according to the maximum parallelism levels of the operation elements, decoding the generated parallelism codes into the process parallelism level for optimizing and adjusting the operation elements comprises:

mapping the generated parallelism codes and the serial numbers of the operation elements, and multiplying the maximum parallelism levels of the operation elements by their correspondingly mapped parallelism codes one by one, and ceiling products into optimizing and adjusting process parallelism levels of the operation elements.

Therein, the multi-objective optimization question is formed by objective functions of the takt time and a total equipment cost of the automated assembly line, and are expressed in equations of:

$$\begin{matrix}min C T = max \{ \{ \frac{{t}_{i}}{{p}_{i}} \vert i ∈ I \} ⋃ \{ {t}_{b} \} \} & ( 1 ) \\ min A = {\sum }_{i = 1}^{N} {A}_{i} {p}_{i} = {\sum }_{j = 2}^{N} {A}_{b} {D}_{j} & ( 2 )\end{matrix}$$

wherein in Equation (1), CT is the takt time of the automated assembly line (i.e. the production rate); tᵢ is the operating time of the operation element i under a condition of a single equipment; pᵢ is the parallelism of the operation element i; I is an operation element set; t_{b} is the operating time of the shunt/confluent unit; in Equation (2), A is the total equipment cost of the automated assembly line; Aᵢ is a cost of a single workstation for an operation i; A_{b} is a cost of a single said shunt or confluent unit; Dⱼ is a 0-1 variable, for an arbitrary process j(2≤j≤N) in the assembly sequence, if pⱼ₋₁≠pⱼ, Dⱼ=1, representing that a said shunt or confluent unit needs to be set between processes j−1 and j; otherwise, Dⱼ=0.

Therein, in Step S5, the step of using Pareto backtracking search optimization algorithm for crowding comprises:

(I) Population initialization

first performing population initialization, so as to obtain a historical population oldP and a current population P, the historical population being used to determine a search direction of every time of iterative evolution, the current population realizing memory of quality configuration schemes for the assembly line by means of an elitism strategy, the population initialization being expressed in:

P_{m,i}˜U(lowᵢ,upᵢ) (3)

oldP_{m,i}˜U(lowᵢ,upᵢ) (4)

wherein in Equations (3) and (4), i=1, 2, 3, . . . , 2N, m=1, 2, 3, . . . , D, and in the configuration-based optimization problems of the automated assembly and production, N represents a number of necessary assembling processes, D represents a population size; lowᵢ and upᵢ represent a lower bound and an upper bound of the i^{th} dimension problem, respectively, and lowᵢ=0, upᵢ=1; U represents an even distribution function;

(II) Selection I

a Selection I operator being mainly for determining the historical population oldP for every iteration, so as to determine a search direction of the iteration, and being expressed in:

$$\begin{matrix}\{ \begin{matrix}oldP := P , a < b \\ oldP := oldP , a \geq b\end{matrix} & ( 5 ) \\ oldP := permutting ( oldP ) & ( 6 )\end{matrix}$$

where, “:=” is an assignment operation; a and b are two random variables satisfying even distribution of U(0,1); permutting is a random shuffle function, for randomly permuting a sequence of codes of the configuration schemes of the assembly line in the historical population;

(III) Mutations

a mutation operator being mainly for generating an initial state of an experimental population T, including respective mutations to the assembly sequence codes and the parallelism codes, and being expressed in:

Mutant=P+F·(oldP−P) (7)

where, F=3·rndn is an amplitude control function of a direction determination matrix (oldP−P), and rndn is a random number satisfying standard normal distribution;

(IV) Crossover

a crossover operator being mainly for generating a final state of the experimental population T, and the initial state of T being Mutant generated by the mutation operator, the crossover operator including two steps:

first, building a mapping matrix map of 2N×D with binary integer values, the mapping matrix map being calculated as:

$$\begin{matrix}{map}_{1 : 2 N , 1 : D} = 1 & ( 8 ) \\ \{ \begin{matrix}{map}_{i , u ( 1 : ⌈ mixrate \cdot D ⌉} = 0 , a < b \\ {map}_{i , randi ( D )} = 0 , a \geq b\end{matrix} & ( 9 )\end{matrix}$$

wherein, in Equation (9), a and b are random numbers satisfying U(0,1) distribution; mixrate is crossover probability, and also the only optimizing parameter in the algorithm that needs to be set, with mixrate=1; randi(D) represents a random integral function evenly distributed on [0, D]; u=permutting(<1, 2, 3, . . . , D>) are integer vectors sorted randomly;

then using the mapping matrix map as guidance to build the experimental population T, selectively mapping the sequence codes and parallelism codes of individuals P_{i,j} in the current population and Mutant on individuals of the experimental population through Equation (10), and using a perimeter control strategy of Equation (11) to set up a search space,

$$\begin{matrix}{T}_{i , j} = \{ \begin{matrix}{P}_{i , j} , {map}_{i , j} = 1 \\ Mutant , {map}_{i , j = 0}\end{matrix} & ( 10 ) \\ {T}_{i , j} = \{ \begin{matrix}{T}_{i , j} , {low}_{j} \leq {T}_{i , j} \leq {up}_{j} \\ rnd \cdot ( {up}_{j} - {low}_{j} ) + {low}_{j} , else\end{matrix} & ( 11 )\end{matrix}$$

wherein, Equation (10) is used to build the experimental population T, Equation (11) is used to set search boundaries of an assembly sequence random key and a parallelism random key, and rnd in Equation (11) is a random variable satisfying U(0,1) even distribution;

(V) Selection II

a Selection II operator comparing objective functions (the takt time and the total equipment cost of the assembly line) using individuals in the current population P and in the experimental population T, and inlaying a crowding-based Pareto assessment strategy into the backtracking search optimization algorithm, so as to realize the memory of elite individuals by means of the elitism strategy;

building Pareto layers including steps of:

Step 1, developing a construction set, placing all initial solutions into the construction set, and calculating objective functions of the initial solutions, with the current layer written as c=0;

Step 2, c=c+1, building a non-dominated solution set of the layer c;

Step 3, finding out all non-dominated solutions in the construction set, and placing all these non-dominated solutions into the non-dominated solution set of the current layer;

Step 4, in the solution set of the current layer, sorting all the solutions according to a certain objective function;

Step 5, determining whether a number of the solutions in the construction set is greater than zero, and if yes, returning to Step 2, otherwise, ending; then screening a target number of the solutions in the Pareto layer, so as to further optimize the population and acquire the optimal solution, wherein assuming that M_{q} solutions have to be screened out, and the number of solutions in the layer c is NUM(c), screening the target number of the solutions comprises steps of:

Step 1, creating a construction set, making a real-time number of the solutions in the construction set be NS, c=1, and acquiring the Pareto layer;

Step 2, if NS+NUM(c)>M_{q}, screening out the individual with the greatest crowding from each said current layer and placing them into the construction set, until NS=M_{q}, and turning to Step 4, otherwise, turning to Step 3; wherein the crowding represents a sum total of distances to the adjacent individuals, and is calculated using an equation below:

$$C {F}_{k} = {\sum }_{l = 1}^{2} \frac{{f}_{k - 1}^{l} - {f}_{k + 1}^{l}}{{f}_{max}^{l} - {f}_{min}^{l}} \qquad ( 12 )$$

wherein in Equation (12), CFₖ represents the crowding of the individual k; ƒₖ^{l} represents a value of the l^{th} objective function of the individual k; ƒₘₐₓ^{l} and ƒₘᵢₙ^{l} represent a maximum value and a minimal value of the l^{th} objective function, respectively, ensuring population diversity throughout the iterations by setting the crowding of the individual as 4;

Step 3, placing all individuals in the current layer into the construction set, c=c+1, turning to Step 2; and

Step 4, outputting the construction set and ending.

By implementing the present invention embodiment, the following beneficial effects can be achieved:

Different from the traditional configuration-based optimization methods of automated assembly and production of circuit breakers, the present invention according to the costs and the maximum parallelism levels of the operation elements, optimizes and adjusts process parallelism levels of the operation elements and their corresponding shunt unit costs or confluent unit costs, and takes the assembly precedence, the process connection and the maximum parallelism levels among the operation elements as constraint conditions, with an objective to minimize a takt time and the costs of the automated assembly and production line, to build the multi-objective optimization problem. The solutions of the problems are configuration-based optimization schemes of automated assembly and production of circuit breakers that can optimizes automated assembly lines of circuit breakers in terms of equipment cost and production efficiency, so as to serve to assembling operations and production of circuit breakers best.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a flowchart of a configuration-based optimization method for automated assembly and production of circuit breakers according to one embodiment of the present invention;

FIG. 2 is a process precedence graph of a configuration-based optimization method for automated assembly and production of circuit breakers showing precedence and process connection among 19 operation elements according to one embodiment of the present invention; and

FIG. 3 is a bar chart showing comparison between the configuration-based optimization schemes obtained in the scene of the configuration-based optimization method for automated assembly and production of circuit breakers according to one embodiment of the present invention and the prior-art configuration-based optimization scheme.

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement, structure, features and effects of the subject matter of the present invention.

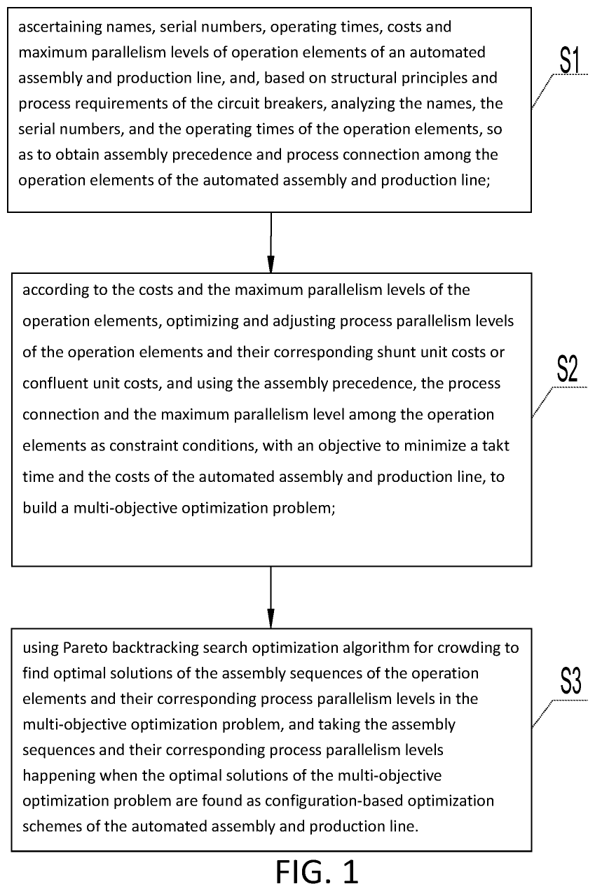

As shown in FIG. 1, in one embodiment of the present invention, a configuration-based optimization method for automated assembly and production of circuit breakers comprises the following steps.

Step S1 includes ascertaining names, serial numbers, operating times, costs and maximum parallelism levels of operation elements of an automated assembly and production line, and, based on structural principles and process requirements of the circuit breakers, analyzing the names, the serial numbers, and the operating times of the operation elements, so as to obtain assembly precedence and process connection among the operation elements of the automated assembly and production line.

Specifically, the automated assembly and production line of circuit breakers includes names and serial numbers of plural operation elements, such as shell feeding, handle feeding, handle fitting and magnetic system feeding. Also included are data about operating times, equipment costs and maximum parallelism levels of the operation elements. The maximum parallelism level depends on a manufacturer's requirements for operation units in terms of equipment volume and site limit. In view of the structural characteristics and construction principles of small circuit breakers, the assembly process is technically demanding. Therefore, assembly precedence and process connection among operation elements of the automated assembly and production line of circuit breakers are of importance.

Assembly precedence comes from part space constraint relationship and construction characteristics of circuit breakers, for preventing interference during assembling works. Process connection comes from special manufacturability of operations such as assembling, testing and pressing circuit breakers, so as to make two operations/processes inseparable. This means that one operation has to be arranged on the next station of another operation, so as to improve assembling reliability and stability. It is understandable that a precedence matrix W and a process connection matrix B can be built according to assembly precedence and process connection among the operation elements.

Assignment meanings of the precedence matrix W and the process connection matrix B is expressed as: if an operation element s is precedent to an operation element r, Wᵣₛ=1, otherwise, Wᵣₛ=0; if there is process connection constraint relationship between an operation element s and an operation element r, and s shall follow an operation s immediately, Bᵣₛ=1, otherwise, Bᵣₛ=0.

In the automated assembly and production line of circuit breakers, the details of the operation elements are shown in Table 1, including nineteen operation elements, such as shell feeding, handle feeding, handle fitting and magnetic system feeding, etc. In terms of system unit, there are system units including part feeding, part mating, part pressing and testing. There are totally 269 serial actions, and 139 parallel actions. There are 327 actions to be completed in every takt time, and the total number of system components is up to 4568.

TABLE 1

| | | Operating | Cost/10 | |
|---|---|---|---|---|
| Serial | | Time/ | Thousand | Maximum |
| Number | Operation Element | Sec. | Yuan | Parallelism |
| 1 | Shell Feeding | 3.0 | 17.5 | 3 |
| 2 | Handle Feeding | 2.9 | 29.8 | 2 |
| 3 | Handle Fitting | 1.3 | 6.8 | 5 |
| 4 | Magnetic System Feeding | 2.4 | 48.3 | 2 |
| 5 | Magnetic System Pressing | 1.4 | 8.9 | 6 |
| 6 | Yoke Feeding | 2.7 | 13.2 | 5 |
| 7 | Aperture 1 Testing | 2.3 | 12.5 | 6 |
| 8 | Hot System Feeding | 5.3 | 21.1 | 3 |
| 9 | Pin Feeding | 2.6 | 14.0 | 6 |
| 10 | Tripper Feeding | 2.4 | 27.7 | 4 |
| 11 | Tripper Positioning | 1.5 | 9.4 | 6 |
| 12 | Large U Feeding | 3.2 | 31.6 | 3 |
| 13 | Small U Feeding | 3.0 | 32.1 | 3 |
| 14 | Arc-Extinguishing | 3.2 | 40.5 | 2 |
| | Chamber Feeding | | | |
| 15 | Flying Filament Feeding | 5.4 | 43.7 | 3 |
| 16 | Aperture 2 Testing | 2.3 | 16.0 | 3 |
| 17 | Cap Closing | 1.9 | 32.1 | 2 |
| 18 | Shell Compacting | 1.3 | 14.2 | 2 |
| 19 | Circuit Breaker Transferring | 2.9 | 16.9 | 2 |

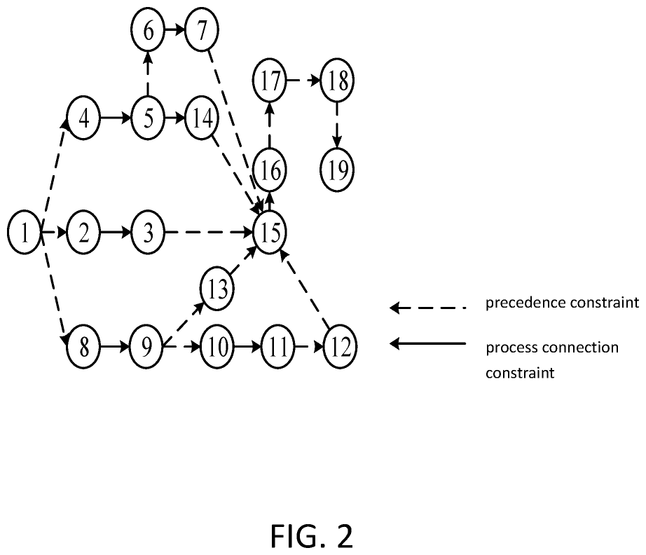

In view of the structural characteristics and construction principles of small circuit breakers, the assembly process has to meet certain manufacturability requirements. The process precedence of the operation elements in Table 1 may be described as the assembly precedence and process connection shown in FIG. 2.

According to FIG. 2, a precedence matrix W and a process connection matrix B can be built as below:

$$W = [ \begin{matrix}0 & 0 & 0 & 0 & 0 & 0 & 0 & 0 & 0 & 0 & 0 & 0 & 0 & 0 & 0 & 0 & 0 & 0 & 0 \\ 1 & 0 & 0 & 0 & 0 & 0 & 0 & 0 & 0 & 0 & 0 & 0 & 0 & 0 & 0 & 0 & 0 & 0 & 0 \\ 1 & 1 & 0 & 0 & 0 & 0 & 0 & 0 & 0 & 0 & 0 & 0 & 0 & 0 & 0 & 0 & 0 & 0 & 0 \\ 1 & 0 & 0 & 0 & 0 & 0 & 0 & 0 & 0 & 0 & 0 & 0 & 0 & 0 & 0 & 0 & 0 & 0 & 0 \\ 1 & 0 & 0 & 1 & 0 & 0 & 0 & 0 & 0 & 0 & 0 & 0 & 0 & 0 & 0 & 0 & 0 & 0 & 0 \\ 1 & 0 & 0 & 1 & 1 & 0 & 0 & 0 & 0 & 0 & 0 & 0 & 0 & 0 & 0 & 0 & 0 & 0 & 0 \\ 1 & 0 & 0 & 1 & 1 & 1 & 0 & 0 & 0 & 0 & 0 & 0 & 0 & 0 & 0 & 0 & 0 & 0 & 0 \\ 1 & 0 & 0 & 0 & 0 & 0 & 0 & 0 & 0 & 0 & 0 & 0 & 0 & 0 & 0 & 0 & 0 & 0 & 0 \\ 1 & 0 & 0 & 0 & 0 & 0 & 0 & 1 & 0 & 0 & 0 & 0 & 0 & 0 & 0 & 0 & 0 & 0 & 0 \\ 1 & 0 & 0 & 0 & 0 & 0 & 0 & 1 & 1 & 0 & 0 & 0 & 0 & 0 & 0 & 0 & 0 & 0 & 0 \\ 1 & 0 & 0 & 0 & 0 & 0 & 0 & 0 & 1 & 1 & 1 & 0 & 0 & 0 & 0 & 0 & 0 & 0 & 0 \\ 1 & 0 & 0 & 0 & 0 & 0 & 0 & 1 & 1 & 1 & 1 & 0 & 0 & 0 & 0 & 0 & 0 & 0 & 0 \\ 1 & 0 & 0 & 0 & 0 & 0 & 0 & 1 & 1 & 0 & 0 & 0 & 0 & 0 & 0 & 0 & 0 & 0 & 0 \\ 1 & 0 & 0 & 1 & 1 & 0 & 0 & 0 & 0 & 0 & 0 & 0 & 0 & 0 & 0 & 0 & 0 & 0 & 0 \\ 1 & 1 & 1 & 1 & 1 & 1 & 1 & 1 & 1 & 1 & 1 & 1 & 1 & 1 & 0 & 0 & 0 & 0 & 0 \\ 1 & 1 & 1 & 1 & 1 & 1 & 1 & 1 & 1 & 1 & 1 & 1 & 1 & 1 & 1 & 0 & 0 & 0 & 0 \\ 1 & 1 & 1 & 1 & 1 & 1 & 1 & 1 & 1 & 1 & 1 & 1 & 1 & 1 & 1 & 1 & 0 & 0 & 0 \\ 1 & 1 & 1 & 1 & 1 & 1 & 1 & 1 & 1 & 1 & 1 & 1 & 1 & 1 & 1 & 1 & 1 & 0 & 0 \\ 1 & 1 & 1 & 1 & 1 & 1 & 1 & 1 & 1 & 1 & 1 & 1 & 1 & 1 & 1 & 1 & 1 & 1 & 0\end{matrix} ]$$

$$B = [ \begin{matrix}0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 1 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 1 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 1 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 1 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 1 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 1 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0\end{matrix} ]$$

wherein, W and B are each a square matrix of order 19, representing assembly precedence and process connection among 19 essential operation elements in an assembly line, respectively.

Step S2 includes according to the costs and the maximum parallelism levels of the operation elements, optimizing and adjusting process parallelism levels of the operation elements and their corresponding shunt unit costs or confluent unit costs, and using the assembly precedence, the process connection and the maximum parallelism level among the operation elements as constraint conditions, with an objective to minimize a takt time and the costs of the automated assembly and production line, to build a multi-objective optimization problem.

Specifically, a multi-objective optimization model is built based on the cost and assembling efficiency under the requirements of parallel station sequence planning and shunt/confluent equipment costs. In view of the discrete nature of decision variables (i.e. the assembling process sequence and the parallel configuration scheme) in the model, a two-stage encoding/decoding approach based on a random key is proposed to allow two-stage decoding conforming to the requirements of assembly precedence, process connection and maximum parallelism, so as to describe the process rigid constraints. The details are given below.

Step S1 includes totaling a total number of the operation elements of the automated assembly and production line, and generating two sections of random two-place decimals that are in a number equal to the total number of the operation elements and distributed evenly in an interval of (0,1), as assembly sequence codes and parallelism codes, respectively.

Step S2 includes according to the serial numbers of the operation elements as well as the assembly precedence and process connection among the operation elements, decoding the generated assembly sequence codes so as to obtain an assembly sequence of the assembly and production line.

Step S3 includes according to the maximum parallelism levels of the operation elements, decoding the generated parallelism codes into the process parallelism level for optimizing and adjusting the operation elements, and according to the costs of the operation elements, further determining shunt unit costs or confluent unit costs corresponding to the optimized and adjusted process parallelism levels of the operation elements.

Step S4 includes taking the shunt unit costs or confluent unit costs corresponding to the assembly precedence and process connection among the operation elements as well as the optimized and adjusted process parallelism levels of the operation elements as the constraint conditions, with an objective to minimize a takt time and the costs of the automated assembly and production line, to build the multi-objective optimization problem.

In Step S1, the backtracking search optimization algorithm is suitable for continuous problems optimization, but multi-objective optimization for process rigid constraints is a discrete problem, making encoding/decoding design for the decision variables necessary. The disclosure employs a random key encoding method, combined with process rigid constraint relationship, and based on the parallel configuration scheme and assembly sequence to perform two-stage encoding to transform discrete decision variables into continuous variables, thereby facilitating optimization and solution finding. Assuming that a total number of the operation elements of the automated assembly production line as calculated is N, two segments of N random two-place decimals evenly distributed in the interval of (0,1) are generated as assembly sequence codes and parallelism codes, respectively. In the automated assembly and production line of circuit breakers, two segments of 19 random two-place decimals that are evenly distributed in the interval of (0,1) are generated according to the 19 operation elements as shown in Table 1.

Step S2 involves according to the serial numbers of the operation elements as well as the assembly precedence and process connection among the operation elements, decoding the first code section (or the assembly sequence code) while mapping the generated assembly sequence codes and the serial numbers of the operation elements, and according to a size of the generated assembly sequence codes, adjusting precedence ranks of the serial numbers of the operation elements, and according to the assembly precedence and process connection among the operation elements, re-adjusting the operation elements having the adjusted serial numbers, further combining the re-adjusted serial numbers of the operation elements into the assembly sequences of the operation elements. At this time, combining the ranks of the operation elements, assembly precedence constraints and process connection constraints, the first code section is compulsorily converted into a feasible solution, so as to set the constraints for assembly precedence and process connection.

Step S3 involves, according to the maximum parallelism levels of the operation elements, decoding the second code section (or the parallelism code), while mapping the generated parallelism codes and the operation elements and multiplying the maximum parallelism levels of the operation elements by their correspondingly mapped parallelism codes one by one, and ceiling products into optimizing and adjusting process parallelism levels of the operation elements;

Then, according to the costs of the operation elements, with reference to the optimized and adjusted process parallelism levels of the operation elements, it is possible to further determine shunt unit costs or confluent unit costs corresponding to the optimized and adjusted process parallelism levels of the operation elements.

Step S4 is about taking the shunt unit costs or confluent unit costs corresponding to the assembly precedence and process connection among the operation elements as well as the optimized and adjusted process parallelism levels among the operation elements as constraint conditions, with an objective to minimize a takt time and the costs of the automated assembly and production line, to build the multi-objective optimization problem.

The multi-objective optimization problem is formed by the objective functions of the takt time and a total equipment cost of the automated assembly line, the objective function of the takt time and the objective function of the total equipment cost, and are expressed in equations of:

$$\begin{matrix}min C T = max \{ \{ \frac{{t}_{i}}{{p}_{i}} \vert i ∈ I \} ⋃ \{ {t}_{b} \} \} & ( 1 ) \\ min A = {\sum }_{i = 1}^{N} {A}_{i} {p}_{i} + {\sum }_{j = 2}^{N} {A}_{b} {D}_{j} & ( 2 )\end{matrix}$$

wherein in Equation (1), CT is the takt time of the automated assembly line (i.e. the production rate); tᵢ is the operating time of the operation element i under a condition of a single equipment; pᵢ is the parallelism of the operation element i; I is an operation element set; t_{b} is the operating time of the shunt/confluent unit; in Equation (2), A is the total equipment cost of the automated assembly line; Aᵢ is a cost of a single workstation for an operation i; A_{b} is a cost of a single said shunt or confluent unit; Dⱼ is a 0-1 variable, for an arbitrary process j(2≤j≤N) in the assembly sequence, if pᵢ₋₁≠pⱼ, Dⱼ=1, representing that a said shunt or confluent unit needs to be set between processes j−1 and j; otherwise, Dⱼ=0, representing that there is no need to set one said shunt or confluent unit between the processes j−1 and j.

Step S5 is about using Pareto backtracking search optimization algorithm for crowding to find optimal solutions of assembly sequences of the operation elements and their corresponding process parallelism levels in the multi-objective optimization question, and taking the assembly sequences and their corresponding process parallelism levels happening when the optimal solutions of the multi-objective optimization question were found as a configuration-based optimization scheme of the automated assembly and production line.

Specifically, the step of using Pareto backtracking search optimization algorithm for crowding comprises five sub-steps, namely population initialization, Selection I, Mutations, Crossover and Selection II, as described below.

(I) Population initialization

The first sub-step is achieved by performing population initialization, so as to obtain a historical population oldP and a current population P, the historical population being used to determine a search direction of every time of iterative evolution, the current population realizing memory of quality configuration schemes for the assembly line by means of an elitism strategy, the population initialization being expressed in:

P_{m,i}˜U(lowᵢ,upᵢ) (3)

oldP_{m,i}˜U(lowᵢ,upᵢ) (4)

wherein in Equations (3) and (4), i=1, 2, 3, . . . , 2N, m=1, 2, 3, . . . , D, and in the configuration-based optimization problems of the automated assembly and production, N represents a number of necessary assembling processes, D represents a population size; lowᵢ and upᵢ represent a lower bound and an upper bound of the i^{th} dimension problem, respectively. From the coding principles it is known that lowᵢ=0, upᵢ=1; U represents an even distribution function.

In one instance, where N=19, D=500, the first 19^{th} denominational element of an individual represents the first code section, or the assembly sequence code, and the last 19^{th} denominational element represents the second code section, or the parallelism code. The encoded individual represents a complete assembly line configuration scheme, including decision control on both the assembly sequence and parallelism.

(II) Selection I

A Selection I operator is mainly for determining the historical population oldP for every iteration, so as to determine a search direction of the iteration, and being expressed in:

$$\begin{matrix}\{ \begin{matrix}oldP := P , a < b \\ oldP := oldP , a \geq b\end{matrix} & ( 5 ) \\ oldP := permutting ( oldP ) & ( 6 )\end{matrix}$$

where, “:=” is an assignment operation; a and b are two random variables satisfying even distribution of U(0,1); permutting is a random shuffle function, for randomly permuting a sequence of codes of the configuration schemes of the assembly line in the historical population.

The Selection I operator makes the backtracking search optimization algorithm have memory, which enables backtracking search. Backtracking and random permutation both help to prevent iterative optimization from being limited by the constraints of local optimal configuration schemes during search of the global optimal assembly line configuration scheme.

(III) Mutations

A mutation operator is mainly for generating an initial state of an experimental population T, including respective mutations to the assembly sequence codes and the parallelism codes, and being expressed in:

Mutant=P+F·(oldP−P) (7)

where, F=3·rndn is an amplitude control function of a direction determination matrix (oldP−P), and rndn is a random number satisfying standard normal distribution.

(IV) Crossover

A crossover operator is mainly for generating a final state of the experimental population T, and the initial state of T being Mutant generated by the mutation operator, the crossover operator including two steps:

The first step is to build a mapping matrix map of 2N×D with binary integer values. The mapping matrix map is calculated as:

$$\begin{matrix}{map}_{1 : 2 N , 1 : D} = 1 & ( 8 ) \\ \{ \begin{matrix}{map}_{i , u ( 1 : ⌈ mixrate \cdot rnd \cdot D ⌉} = 0 , a < b \\ {map}_{i , randi ( D )} = 0 , a \geq b\end{matrix} & ( 9 )\end{matrix}$$

wherein, in Equation (9), a and b are random numbers satisfying U(0,1) distribution; mixrate is crossover probability, and also the only optimizing parameter in the algorithm that needs to be set, with mixrate=1; randi(D) represents a random integral function evenly distributed on [0, D]; u=permutting(<1, 2, 3, . . . , D>) are integer vectors sorted randomly.

The second step is about using the mapping matrix map as guidance to build the experimental population T, selectively mapping the sequence codes and parallelism codes of individuals P_{i,j} in the current population and Mutant on individuals of the experimental population through Equation (10), and using a perimeter control strategy of Equation (11) to set up a search space,

$$\begin{matrix}{T}_{i , j} = \{ \begin{matrix}{P}_{i , j} , {map}_{i , j} = 1 \\ Mutant , {map}_{i , j = 0}\end{matrix} & ( 10 ) \\ {T}_{i , j} = \{ \begin{matrix}{T}_{i , j} , {low}_{j} \leq {T}_{i , j} \leq {up}_{j} \\ rnd \cdot ( {up}_{j} - {low}_{j} ) + {low}_{j} , else\end{matrix} & ( 11 )\end{matrix}$$

wherein, Equation (10) is used to build the experimental population T, Equation (11) is used to set search boundaries of an assembly sequence random key and a parallelism random key, and rnd in Equation (11) is a random variable satisfying U(0,1) even distribution.

The mutation operator and the crossover operator are for generating new individuals, so as to discover potential better configuration-based optimization schemes for the automated assembly and production line of circuit breakers.

(V) Selection II

A Selection II operator compares objective functions (the takt time and the total equipment cost of the assembly line) using individuals in the current population P and in the experimental population T, and inlaying a crowding-based Pareto assessment strategy into the backtracking search optimization algorithm, so as to realize the memory of elite individuals by means of the elitism strategy.

First, building Pareto layers includes steps of:

Step 1, developing a construction set, placing all initial solutions into the construction set, and calculating objective functions of the initial solutions, with the current layer written as c=0;

Step 2, c=c+1, building a non-dominated solution set of the layer c;

Step 3, finding out all non-dominated solutions in the construction set, and placing all these non-dominated solutions into the non-dominated solution set of the current layer;

Step 4, in the solution set of the current layer, sorting all the solutions according to a certain objective function; and

Step 5, determining whether a number of the solutions in the construction set is greater than zero, and if yes, returning to Step 2, otherwise, ending.

Through the foregoing steps, the Pareto layer can be built, so as to achieve multi-objective evaluation of assembling equipment costs and production efficiency.

Then the method is further completed by screening a target number of the solutions in the Pareto layer, so as to further optimize the population and acquire the optimal solution, wherein assuming that M_{q} solutions have to be screened out, and the number of solutions in the layer c is NUM(c), screening the target number of the solutions comprises steps of:

Step 1, creating a construction set, making a real-time number of the solutions in the construction set be NS, c=1, and acquiring the Pareto layer;

Step 2, if NS+NUM(c)>M_{q}, screening out the individual with the greatest crowding from each said current layer and placing them into the construction set, until NS=M_{q}, and turning to Step 4, otherwise, turning to Step 3; wherein the crowding represents a sum total of distances to the adjacent individuals, and is calculated using an equation below:

$$C {F}_{k} = {\sum }_{l = 1}^{2} \frac{{f}_{k - 1}^{l} - {f}_{k + 1}^{l}}{{f}_{max}^{l} - {f}_{min}^{l}} \qquad ( 12 )$$

wherein in Equation (12), CFₖ represents the crowding of the individual k; ƒₖ^{l} represents a value of the l^{th} objective function of the individual k; ƒₘₐₓ^{l} and ƒₘᵢₙ^{l} represent a maximum value and a minimal value of the l^{th} objective function, respectively, ensuring population diversity throughout the iterations by setting the crowding of the individual as 4;

Step 3, placing all individuals in the current layer into the construction set, c=c+1, turning to Step 2; and

Step 4, outputting the construction set and ending.

During every iteration, in the mixed population composed of the current population P and the experimental population T, the Pareto assessment strategy is used to screen out individuals equivalent to a population size D, and these individuals are taken as the current population P for the next iteration. When the iteration ends, all solutions that are of Layer 1 are screened out from the final Pareto layer, and those individuals having too long takt times or too high total equipment costs are rejected, so as to obtain plural desired optimal solutions. The configuration-based optimization schemes corresponding to the optimal solutions are the configuration-based optimization schemes of the automated assembly and production line.

In the embodiment, it is assumed that the automated assembly and production line of circuit breakers has an upper limit for its total cost of 90000 thousand Yuan, an upper limit for its cycle of 4 sec./layer, a population size D of 500, a number of iterations itnₘₐₓ of 1000, and a mix rate mixrate of 1. The results of experimental calculation are shown in Table 2. These schemes contribute to optimization of the layout cost and the production rate of a real-world assembly line of circuit breakers.

TABLE 2

| | | | | Assembly |
|---|---|---|---|---|
| | | | Cost/10 | Line |
| Serial | Configuration | | Thousand | Cycle/ |
| Number | Type | Scheme Details | Yuan | Sec. |
| 1 | Assembly | (1, 4, 5, 8 , 9, 2, 3, 6, 7, 13, 10, 11, 14, 12, | 517.5 | 3.2 |
| | Sequence | 15, 16, 17, 18, 19) | | |
| | Process | (1, 1, 1, 2, 1, 1, 1, 1, 1, 1, 1, 1, 1, 1, 2, | | |
| | Parallelism | 1, 1, 1, 1) | | |
| 2 | Assembly | (1, 8, 9, 4, 5, 13, 6, 7, 10, 11, 2, 3, 14, 12, | 589.6 | 3.0 |
| | Sequence | 15, 16, 17, 18, 19) | | |
| | Process | (1, 2, 1, 1, 1, 1, 1, 1, 1, 1, 1, 1, 2, 2, 2, | | |
| | Parallelism | 1, 1, 1, 1) | | |
| 3 | Assembly | (1, 8, 9, 10, 11, 2, 3, 4, 5, 6, 7, 12, 13, 14, 15, | 635.1 | 2.9 |
| | Sequence | 16, 17, 18, 19) | | |
| | Process | (2, 2, 1, 1, 1, 1, 1, 1, 1, 1, 1, 2, 2, 2, 2, 1, | | |
| | Parallelism | 1, 1, 1) | | |
| 4 | Assembly | (1, 8, 9, 10, 11, 4, 5, 6, 7, 12, 13, 14, 2, 3, 15, | 694.1 | 2.7 |
| | Sequence | 16, 17, 18, 19) | | |
| | Process | (2, 2, 1, 1, 1, 1, 1, 1, 1, 2, 2, 2, 2, 1, 2, 1, | | |
| | Parallelism | 1, 1, 1) | | |
| 5 | Assembly | (1, 2, 3, 8, 9, 4, 5, 10, 11, 12, 13, 14, 6, 7, 15, | 759.2 | 2.65 |
| | Sequence | 16, 17, 18, 19) | | |
| | Process | (2, 2, 1, 2, 1, 1, 1, 1, 1, 2, 2, 2, 2, 1, 3, 1, | | |
| | Parallelism | 1, 1, 2) | | |
| 6 | Assembly | (1, 2, 3, 4, 5, 6, 7, 8, 9, 10, 11, 12, 13, 14, 15, | 784.4 | 2.6 |
| | Sequence | 16, 17, 18, 19) | | |
| | Process | (2, 2, 1, 1, 1, 2, 1, 3, 1, 1, 1, 2, 2, 2, 3, 1, | | |
| | Parallelism | 1, 1, 2) | | |
| 7 | Assembly | (1, 2, 3, 4, 5, 8, 9, 13, 14, 6, 7, 10, 11, 12, 15, | 794.3 | 2.4 |
| | Sequence | 16, 17, 18, 19) | | |
| | Process | (2, 2, 1, 1, 1, 3, 2, 2, 2, 2, 1, 1, 1, 2, 3, 1, | | |
| | Parallelism | 1, 1, 2) | | |
| 8 | Assembly | (1, 2, 3, 8, 9, 10, 11, 13, 12, 4, 5, 14, 6, 7, 15, | 885.3 | 2.3 |
| | Sequence | 16, 17, 18, 19) | | |
| | Process | (2, 2, 2, 3, 2, 2, 2, 2, 2, 2, 2, 2, 2, 1, 3, 1, | | |
| | Parallelism | 1, 1, 2) | | |

In the embodiment of the present invention, these configuration-based optimization schemes are all actual optimal schemes, and within the range defined by the cost and cycle constraints, there are no other configuration schemes that can dominate over them. Meanwhile, decisions of the optimal solution set can be made for these optimization solutions according to the profit. Therefore, the method further comprises:

acquiring costs of the automated assembly and production line in the configuration-based optimization schemes happening when the optimal solutions of the multi-objective optimization question were found, and according to the acquired costs of the automated assembly and production line in the configuration-based optimization schemes, figuring out total profits of the configuration-based optimization schemes at an end of a business payback period, and further taking the configuration-based optimization scheme having the greatest total profit as the final configuration-based optimization scheme of the automated assembly and production line.

In the example, decisions are made to the optimization solution set listed in Table 2 according to business requirements. Assuming that a business has a payback period of 2 years, the configuration scheme providing the greatest benefit in 2 years is taken as the final result. The profit is calculated using the equation below:

$$N P = \frac{3600 \times {k}_{y} {k}_{d} {k}_{h} {k}_{a} {k}_{f} {k}_{r} {p}_{b}}{10000 \times C T} - A$$

where NP represents the total profit, k_{y} represents the number of operation years of the assembly line, set as k_{y}=2, k_{d} represents the number of working days per year, set as k_{d}=300; kₕ represents the number of working hours per day, set as kₕ=16; kₐ is the operation attendance rate, set as kₐ=0.8; k_{ƒ} represents the proportion of the equipment constant failure-rate period, set as k_{ƒ}=0.9; kᵣ is the profit rate of small circuit breakers, set as kᵣ=0.08; p_{b} is the unit price of the small circuit breakers, set as p_{b}=10; CT represents the takt time of a scheme; A represents the total equipment cost of a scheme; 3600 represents the number of seconds in one hour, and 10000 is for converting Yuan into ten thousand Yuan.

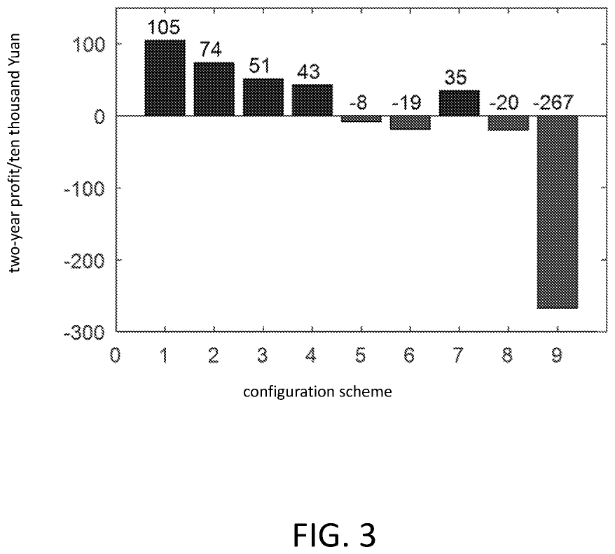

Calculation performed using the 8 configuration-based optimization schemes of Table 2 and the existing assembly line scheme (with a cost of 6.36 ten thousand Yuan, and a takt time of 5.4 sec./layer) shows comparison of the schemes in terms of 2-year profit, based on which a profit comparison bar chart as shown in FIG. 3 can be plotted.

In FIG. 3, Configuration schemes 1-8 correspond to the configuration schemes numbered 1-8 in Table 2, respectively, and Scheme 9 is the existing assembly line scheme. The two-year profit of each scheme is shown as the corresponding bar. From the comparison of FIG. 3, it is known that configuration scheme 1 could contribute to the greatest net profit (about 105 ten thousand Yuan) in two years. According to the specific needs of the business, Scheme 1 is the optimal configuration scheme for it increases the production efficiency by 40.7% and reduces the equipment cost by 18.6% as compared with the existing scheme.

By implementing the present embodiment, the following beneficial effects can be achieved:

Different from the traditional configuration-based optimization methods of automated assembly and production lines of circuit breakers, the present invention according to the costs and the maximum parallelism levels of the operation elements, optimizes and adjusts process parallelism levels of the operation elements and their corresponding shunt unit costs or confluent unit costs, and takes the assembly precedence, the process connection and the maximum parallelism levels among the operation elements as constraint conditions, with an objective to minimize a takt time and the costs of the automated assembly and production line, to build the multi-objective optimization problem. The solutions of the problems are configuration-based optimization schemes of automated assembly and production of circuit breakers that can optimize automated assembly lines of circuit breakers in terms of equipment cost and production efficiency, so as to serve to assembling operations and production of circuit breakers best.

People of ordinary skill in the art shall understand that all or some of the steps of the foregoing embodiment may be realized using programs that instruct related hardware. Such programs may be stored in a computer-readable storage medium, such as a ROM/RAM, a disk or an optical disc.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A configuration-based optimization method for automated assembly and production of circuit breakers, comprising steps of:
Step S1, ascertaining names, serial numbers, operating times, costs and maximum parallelism levels of operation elements of an automated assembly and production line, and, based on structural principles and process requirements of the circuit breakers, analyzing the names, the serial numbers, and the operating times of the operation elements, so as to obtain assembly precedence and process connection among the operation elements of the automated assembly and production line;
Step S2, according to the costs and the maximum parallelism levels of the operation elements, optimizing and adjusting process parallelism levels of the operation elements and their corresponding shunt unit costs or confluent unit costs, and using the assembly precedence, the process connection and the maximum parallelism level among the operation elements as constraint conditions, with an objective to minimize a takt time and the costs of the automated assembly and production line, to build a multi-objective optimization problem;
Step S3, using Pareto backtracking search optimization algorithm for crowding to find optimal solutions of the assembly sequences of the operation elements and their corresponding process parallelism levels in the multi-objective optimization problem, and taking the assembly sequences and their corresponding process parallelism levels happening when the optimal solutions of the multi-objective optimization problem are found as configuration-based optimization schemes of the automated assembly and production line.

2. The method of claim 1, further comprising:
acquiring costs of the automated assembly and production line in the configuration-based optimization schemes happening when the optimal solutions of the multi-objective optimization problem are found, and according to the acquired costs of the automated assembly and production line in the configuration-based optimization schemes, figuring out total profits of the configuration-based optimization schemes at an end of a business payback period, and further taking the configuration-based optimization scheme having the greatest total profit as the final configuration-based optimization scheme of the automated assembly and production line.

3. The method of claim 1, wherein Step S2 comprises:
totaling a total number of the operation elements of the automated assembly and production line, and generating two sections of random two-place decimals that are in a number equal to the total number of the operation elements and distributed evenly in an interval of (0,1), as assembly sequence codes and parallelism codes, respectively;
according to the serial numbers of the operation elements as well as the assembly precedence and process connection among the operation elements, decoding the generated assembly sequence codes so as to obtain an assembly sequence of the assembly and production line;
according to the maximum parallelism levels of the operation elements, decoding the generated parallelism codes into the process parallelism levels for optimizing and adjusting the operation elements, and according to the costs of the operation elements, further determining the shunt unit costs or the confluent unit costs corresponding to the optimized and adjusted process parallelism levels of the operation elements;
taking the assembly precedence, the process connection and the maximum parallelism levels among the operation elements as the constraint conditions, with an objective to minimize the takt time and the costs of the automated assembly and production line, to build the multi-objective optimization problem.

4. The method of claim 3, wherein the step of according to the serial numbers of the operation elements as well as the assembly precedence and process connection among the operation elements, decoding the generated assembly sequence codes so as to obtain the assembly sequence of the assembly and production line comprises:
mapping the generated assembly sequence codes and the serial numbers of the operation elements, and according to a size of the generated assembly sequence codes, adjusting precedence ranks of the serial numbers of the operation elements, and according to the assembly precedence and process connection among the operation elements, re-adjusting the operation elements having the adjusted serial numbers, further combining the re-adjusted serial numbers of the operation elements into the assembly sequences of the operation elements.

5. The method of claim 3, wherein the step of according to the maximum parallelism levels of the operation elements, decoding the generated parallelism codes into the process parallelism levels for optimizing and adjusting the operation elements comprises:
mapping the generated parallelism codes and the serial numbers of the operation elements, and multiplying the maximum parallelism levels of the operation elements by their correspondingly mapped parallelism codes one by one, and ceiling products into optimizing and adjusting process parallelism levels of the operation elements.

6. The method of claim 3, wherein the multi-objective optimization problem is formed by objective functions of the takt time and a total equipment cost of the automated assembly line, and are expressed in equations of:
$$\begin{matrix}min C T = max \{ \{ \frac{{t}_{i}}{{p}_{i}} \vert i ∈ I \} ⋃ \{ {t}_{b} \} \} & ( 1 ) \\ min A = {\sum }_{i = 1}^{N} {A}_{i} {p}_{i} + {\sum }_{j = 2}^{N} {A}_{b} {D}_{j} & ( 2 )\end{matrix}$$
wherein in Equation (1), CT is the takt time of the automated assembly line (i.e. the production rate); tᵢ is the operating time of the operation element i under a condition of a single equipment; pᵢ is the parallelism of the operation element i; I is an operation element set; t_{b} is the operating time of the shunt/confluent unit; in Equation (2), A is the total equipment cost of the automated assembly line; Aᵢ is a cost of a single workstation for an operation i; A_{b} is a cost of a single said shunt or confluent unit; Dⱼ is a 0-1 variable, for an arbitrary process j(2≤j≤N) in the assembly sequences, if pⱼ₋₁≠pⱼ, Dⱼ=1, representing that a said shunt or confluent unit needs to be set between processes j−1 and j; otherwise, Dⱼ=0, representing that there is no need to set one said shunt or confluent unit between the processes j−1 and j.

7. The method of claim 1, wherein in Step S5, the step of using Pareto backtracking search optimization algorithm for crowding comprises:
(I) Population initialization
first performing population initialization, so as to obtain a historical population oldP and a current population P, the historical population being used to determine a search direction of every time of iterative evolution, the current population realizing memory of quality configuration schemes for the assembly line by means of an elitism strategy, the population initialization being expressed in:
P_{m,i}˜U(lowᵢ,upᵢ) (3)
oldP_{m,i}˜U(lowᵢ,upᵢ) (4)
wherein in Equations (3) and (4), i=1, 2, 3, . . . , 2N, m=1, 2, 3, . . . , D, and in the configuration-based optimization problems of the automated assembly and production, N represents a number of necessary assembling processes, D represents a population size; lowᵢ and upᵢ represent a lower bound and an upper bound of the i^{th} dimension problem, respectively, and lowᵢ=0, upᵢ=1; U represents an even distribution function;
(II) Selection I
a Selection I operator being mainly for determining the historical population oldP for every iteration, so as to determine a search direction of the iteration, and being expressed in:
$$\begin{matrix}\{ \begin{matrix}oldP := P , a < b \\ oldP := oldP , a \geq b\end{matrix} & ( 5 ) \\ oldP := permutting ( oldP ) & ( 6 )\end{matrix}$$
where, “:=” is an assignment operation; a and b are two random variables satisfying even distribution of U(0,1); permutting is a random shuffle function, for randomly permuting a sequence of codes of the configuration schemes of the assembly line in the historical population;
(III) Mutations
a mutation operator being mainly for generating an initial state of an experimental population T, including respective mutations to the assembly sequence codes and the parallelism codes, and being expressed in:
Mutant=P+F·(oldP−P) (7)
where, F=3·rndn is an amplitude control function of a direction determination matrix (oldP−P), and rndn is a random number satisfying standard normal distribution;
(IV) Crossover
a crossover operator being mainly for generating a final state of the experimental population T, and the initial state of T being Mutant generated by the mutation operator, the crossover operator including two steps:
first, building a mapping matrix map of 2N×D with binary integer values, the mapping matrix map being calculated as:
$$\begin{matrix}{map}_{1 : 2 N , 1 : D} = 1 & ( 8 ) \\ \{ \begin{matrix}{map}_{i , u ( 1 : ⌈ mixrate \cdot rnd \cdot D ⌉} = 0 , a < b \\ {map}_{i , randi ( D )} = 0 , a \geq b\end{matrix} & ( 9 )\end{matrix}$$
wherein, in Equation (9), a and b are random numbers satisfying U(0,1) distribution; mixrate is crossover probability, and also the only optimizing parameter in the algorithm that needs to be set, with mixrate=1; randi(D) represents a random integral function evenly distributed on [0, D]; u=permutting(<1, 2, 3, . . . , D>) are integer vectors sorted randomly;
then using the mapping matrix map as guidance to build the experimental population T, selectively mapping the sequence codes and parallelism codes of individuals P_{i,j} in the current population and Mutant on individuals of the experimental population through Equation (10), and using a perimeter control strategy of Equation (11) to set up a search space,
$$\begin{matrix}{T}_{i , j} = \{ \begin{matrix}{P}_{i , j} , {map}_{i , j} = 1 \\ Mutant , {map}_{i , j = 0}\end{matrix} & ( 10 ) \\ {T}_{i , j} = \{ \begin{matrix}{T}_{i , j} , {low}_{j} \leq {T}_{i , j} \leq {up}_{j} \\ rnd \cdot ( {up}_{j} - {low}_{j} ) + {low}_{j} , else\end{matrix} & ( 11 )\end{matrix}$$
wherein, Equation (10) is used to build the experimental population T, Equation (11) is used to set search boundaries of an assembly sequence random key and a parallelism random key, and rnd in Equation (11) is a random variable satisfying U(0,1) even distribution;
(V) Selection II
a Selection II operator comparing objective functions (the takt time and the total equipment cost of the assembly line) using individuals in the current population P and in the experimental population T, and inlaying a crowding-based Pareto assessment strategy into the backtracking search optimization algorithm, so as to realize the memory of elite individuals by means of the elitism strategy;
building Pareto layers including steps of:
Step 1, developing a construction set, placing all initial solutions into the construction set, and calculating objective functions of the initial solutions, with the current layer written as c=0;
Step 2, c=c+1, building a non-dominated solution set of the layer c;
Step 3, finding out all non-dominated solutions in the construction set, and placing all these non-dominated solutions into the non-dominated solution set of the current layer;
Step 4, in the solution set of the current layer, sorting all the solutions according to a certain objective function; and
Step 5, determining whether a number of the solutions in the construction set is greater than zero, and if yes, returning to Step 2, otherwise, ending;
then screening a target number of the solutions in the Pareto layer, so as to further optimize the population and acquire the optimal solution, wherein assuming that M_{q} solutions have to be screened out, and the number of solutions in the layer c is NUM(c), screening the target number of the solutions comprises steps of:
Step 1, creating a construction set, making a real-time number of the solutions in the construction set be NS, current layer c=1, and acquiring the Pareto layer;
Step 2, if NS+NUM(c)>M_{q}, screening out the individual with the greatest crowding from each said current layer and placing them into the construction set, until NS=M_{q}, and turning to Step 4, otherwise, turning to Step 3; wherein the crowding represents a sum total of distances to the adjacent said individuals, and is calculated using an equation below:
$$C {F}_{k} = {\sum }_{l = 1}^{2} \frac{{f}_{k - 1}^{l} - {f}_{k + 1}^{l}}{{f}_{max}^{l} - {f}_{min}^{l}} \qquad ( 12 )$$
wherein in Equation (12), CFₖ represents the crowding of the individual k; ƒₖ^{l} represents a value of the l^{th} objective function of the individual k; ƒₘₐₓ^{l} and ƒₘᵢₙ^{l} represent a maximum value and a minimal value of the l^{th} objective function, respectively, ensuring population diversity throughout the iterations by setting the crowding of the individual as 4;
Step 3, placing all individuals in the current layer into the construction set, c=c+1, turning to Step 2; and
Step 4, outputting the construction set and ending.
